(19) United States
(12) Patent Application Publication
(10) Pub. No.: US 2019/0331635 A1
(43) Pub. Date: Oct. 31, 2019

(54) SOLID ELECTROLYTE BODY FOR GAS SENSOR ELEMENT, PRODUCTION METHOD THEREOF AND GAS SENSOR ELEMENT

(71) Applicant: DENSO CORPORATION, Kariya-city, Aichi-pref. (JP)

(72) Inventors: Mitsuhiro YOSHIDA, Kariya-city, Aichi-pref. (JP); Satoshi SUZUKI, Kariya-city, Aichi-pref. (JP)

(21) Appl. No.: 16/349,770

(22) PCT Filed: Nov. 13, 2017
(86) PCT No.: PCT/JP2017/040685

§ 371 Date: May 14, 2019

(30) Foreign Application Priority Data
Nov. 15, 2016 (JP) 2016-222320

(51) Int. Cl. G01N 27/407; C04B 35/488; G01N 27/409

(52) U.S. Cl. CPC G01N 27/4075; G01N 27/409; C04B 35/4885

(57) ABSTRACT

A solid electrolyte body for a gas sensor element constituted by solid electrolyte particles made of zirconia containing a stabilizer has a structure in which metal oxide particles are dispersed in a solid electrolyte phase in which a large number of the solid electrolyte particles are aggregated, and, in the solid electrolyte phase, pairs of the solid electrolyte particles adjoining each other do not have a grain boundary impurity layer between their particle interfaces, and the particle interfaces directly contact with each other.

### CROSS-REFERENCE TO RELATED APPLICATION

This application is based on and claims the benefit of priority from earlier Japanese Patent Application No. 2016-222320 filed Nov. 15, 2016, the entire content of the patent application of which is incorporated herein by reference.

### TECHNICAL FIELD

The present disclosure relates to a solid electrolyte body for a gas sensor element used for a gas sensor element for detecting a specific gas component, a production method thereof, and a gas sensor element using the same.

### BACKGROUND ART

In an exhaust system and the like of an internal combustion engine, a gas sensor is often placed to detect oxygen concentration, air-fuel ratio and the like in an exhaust gas, and to feed the detected results back to a combustion control system of the internal combustion engine. Such a gas sensor is provided with a gas sensor element using a solid electrolyte body having oxide ionic conductivity. For example, a pair of electrodes are provided on the inner and outer surfaces of the solid electrolyte body, where one of the electrodes is exposed to exhaust gas, and oxygen concentration is detected from the electromotive force generated between the pair of electrodes.

In recent years, exhaust gas regulations of vehicle engines have been tightened, and concurrently further improvements in fuel efficiency are called upon. For example, combustion control at the time of starting an engine is important to reduce emissions, and combustion properties at the time of starting an engine can be improved by activating the gas sensor at an earlier point. However, since the gas sensor element is activated early, at the time of starting an engine when the temperature of the exhaust gas is low, stress may be generated in the solid electrolyte body and the electrolyte body may develop cracks and the like due to the rapid temperature rise.

Moreover, as hybrid vehicles and idling stop vehicles restart repeatedly, power consumption of a heater increases and causes reduction of fuel efficiency. As such, it is expected that the control of combustion behavior at the time of starting an engine will be improved while preventing damage to the solid electrolyte body and suppressing reduction of fuel efficiency by improving low temperature activation of the gas sensor element.

Patent Literature 1 discloses a solid electrolyte for a gas sensor formed by dispersing alumina in grain boundaries of zirconia using yttria. In the solid electrolyte, the content of yttria is 2 to 10 mol % of zirconia, the content of alumina is 5 to 25% by mass of the entire solid electrolyte and has a relative density of 93% or more. Further, by regulating the average particle size of zirconia particles and that of alumina particles to a predetermined relationship and homogeneously dispersing alumina particles smaller than zirconia particles, grain boundary resistance and intraparticle resistance of zirconia are controlled, and ionic conductivity and thermal shock resistance are intended to be improved.

### CITATION LIST

### Patent Literature

[PTL 1]: JP 4724772 B

### SUMMARY OF THE INVENTION

In the gas sensor element, the detection sensitivity of the gas sensor element increases by improving ionic conductivity of the solid electrolyte body, and it becomes possible to detect a specific gas component in a state where the element temperature is lower. The constitution of Patent Literature 1 is a constitution where insulating alumina particles are dispersed in the grain boundaries of zirconia that is a solid electrolyte, and therefore it was found that there is a limit in improving ionic conductivity and that it was impossible to obtain desired low temperature starting properties.

An object of the present disclosure is to provide a solid electrolyte body for a gas sensor element capable of activation at a lower temperature and having excellent thermal shock resistance at elevated temperatures by further improving ionic conductivity, a production method thereof, and a gas sensor using the same.

One aspect of the present disclosure is,

a solid electrolyte body for a gas sensor element containing solid electrolyte particles made of zirconia containing a stabilizer, and metal oxide particles, the solid electrolyte body having a structure in which the metal oxide particles are dispersed in a solid electrolyte phase in which a large number of the solid electrolyte particles are aggregated,

wherein, in the solid electrolyte phase, pairs of the solid electrolyte particles adjoining each other do not have a grain boundary impurity layer between their particle interfaces, and the particle interfaces directly contact with each other.

Another aspect of the present disclosure is a method of producing the solid electrolyte body for a gas sensor element, comprising the steps of:

a pulverizing step of pulverizing a raw material of the solid electrolyte particles;

a slurrying step of mixing a pulverized raw material powder with a solvent to form a slurry;

a filtering step of separating impurities together with the solvent from the raw material powder by performing centrifugal separation treatment on the obtained slurry;

a mixing step of adding the metal oxide particles to the separated raw material powder;

a molding step of molding a mixed powder containing the raw material powder and the metal oxide particles into a molded body.

Still another aspect of the present disclosure is a gas sensor element using the solid electrolyte body for a gas sensor element, wherein the gas sensor element has the solid electrolyte body for a gas sensor element and a pair of electrodes, and

the solid electrolyte body for a gas sensor element is provided with a measuring electrode of the pair of electrodes on a first surface contacting a gas to be measured containing a specific gas component, and a reference electrode of the pair of electrodes on a second surface contacting a reference gas.

### Advantageous Effects of the Invention

In the solid electrolyte body for a gas sensor element, at least a portion of the particle interfaces of two mutually adjacent solid electrolyte particles are in direct contact in the solid electrolyte phase. In this portion, since the grain boundary impurity layer which is an inhibiting factor of ionic conduction does not intervene in the particle interface of the solid electrolyte particles, ionic conduction between adjacent particle interfaces is promptly performed, and ionic conductivity is improved. Moreover, the metal oxide particles dispersed in the solid electrolyte phase contribute to improvement in strength. Since a gas sensor element using such a solid electrolyte body can be activated at a lower temperature, it is used, for example, to control combustion of an engine, and improves controllability at the time of starting an engine and contributes to suppress exhaust emissions. Moreover, since a rapid temperature rise is no longer necessary and strength improves, damage to the solid electrolyte body is prevented and heater power consumption at the time of restart is reduced, and therefore fuel efficiency improves.

Such a solid electrolyte body for a gas sensor element can be produced by undergoing a filtering step after performing a pulverizing step of a raw material and a slurrying step. In the filtering step, the raw material powder is separated from the solvent by centrifugation, and the trace amount of impurities contained in the slurry remains in the solvent, and therefore a raw material powder containing no impurities can be obtained. Then, a mixing step and a molding step of the metal oxide particles are performed, and by firing the resultant molded body, a solid electrolyte body having no grain boundary impurity layer in the interfaces of the solid electrolyte particles where particle interfaces directly contact with each other.

As described above, according to the above mentioned aspect, it is possible to realize a solid electrolyte body for a gas sensor element having further improved ionic conductivity, capable of activation at a lower temperature, and having excellent thermal shock resistance at the time of temperature rise. Moreover, it is possible to provide a production method thereof and a gas sensor using the same.

### BRIEF DESCRIPTION OF THE DRAWINGS

The object mentioned above and other objects, features and advantages of the present disclosure shall become more evident by the following detailed description with reference to the accompanying drawings. In the accompanying drawings:

FIG. 1 is a view schematically showing a structure of a solid electrolyte body for a gas sensor element in a first embodiment of the present disclosure;

FIG. 2 is a schematic structural view of the solid electrolyte body for a gas sensor element in a first embodiment of the present disclosure, and is a view schematically showing a state where metal oxide particles are dispersed in a solid electrolyte phase;

FIG. 3 is a schematic view for explaining the relationship between particle interfaces and ionic conductivity of the solid electrolyte body for a gas sensor element in a first embodiment of the present disclosure;

FIG. 4 is a partial cross-sectional view showing a schematic configuration of an example of a gas sensor element where the solid electrolyte body for a gas sensor element is applied in a first embodiment of the present disclosure;

FIG. 5 is a partial cross-sectional view showing a schematic configuration of another example of a gas sensor element where the solid electrolyte body for a gas sensor element is applied in a first embodiment of the present disclosure;

FIG. 6 is a STEM photograph showing a structure of a solid electrolyte body for a gas sensor element in an example of the present disclosure;

FIG. 7 is a STEM photograph showing a structure of a solid electrolyte body for a gas sensor element in an example of the present disclosure;

FIG. 8 is a STEM photograph showing a structure of a solid electrolyte body for a gas sensor element, and enlarging region VIII of FIG. 7 in an example of the present disclosure;

FIG. 9 is a STEM photograph showing a structure of a conventional solid electrolyte body for a gas sensor element in an example of the present disclosure;

FIG. 10 is a view schematically showing the relationship between a structure and ionic conductivity of a conventional solid electrolyte body for a gas sensor element in an example of the present disclosure;

FIG. 11 is a view showing the relationship between ionic conductivity and activation temperature in an example of the present disclosure;

FIG. 12 is a view showing the relationship between alumina content, ionic conductivity and bending strength in an example of the present disclosure; and

FIG. 13 is a view showing the relationship between alumina content, ionic conductivity and bending strength in an example of the present disclosure.

### DESCRIPTION OF THE EMBODIMENTS

### First Embodiment

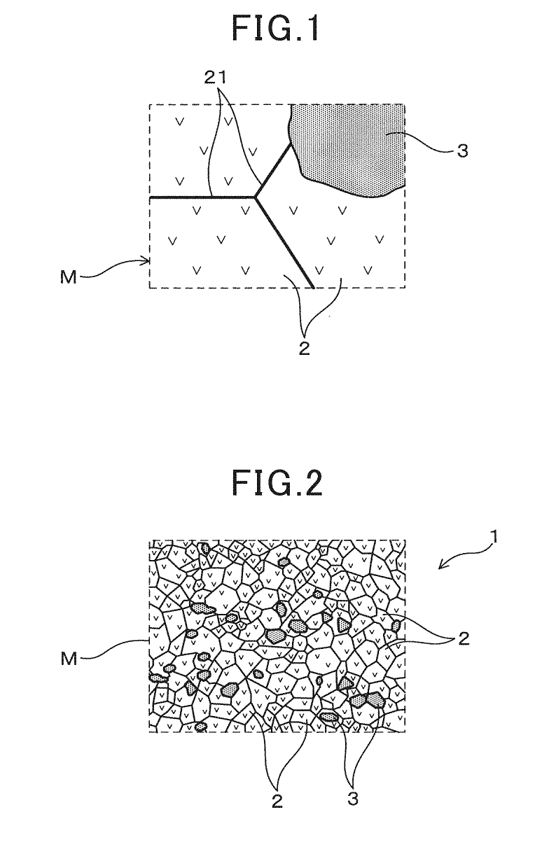

An Embodiment relating to a solid electrolyte for a gas sensor element and a gas sensor element using the same shall be described with reference to FIG. 1 to FIG. 5. As shown in FIG. 2, a solid electrolyte body 1 comprises solid electrolyte particles 2 made of zirconia containing a stabilizer and metal oxide particles 3. Specifically, as shown in FIG. 1, the solid electrolyte body 1 has a structure having a solid electrolyte phase M formed by aggregating a large number of solid electrolyte particles 2, and a plurality of metal oxide particles 3 are dispersed in the solid electrolyte phase M. The solid electrolyte phase M is a polycrystalline phase where a large number of solid electrolyte particles 2 are continuously arranged so as to surround each other. In the present aspect, the solid electrolyte body 1 does not contain particles other than the solid electrolyte particles 2 and the metal oxide particles 3.

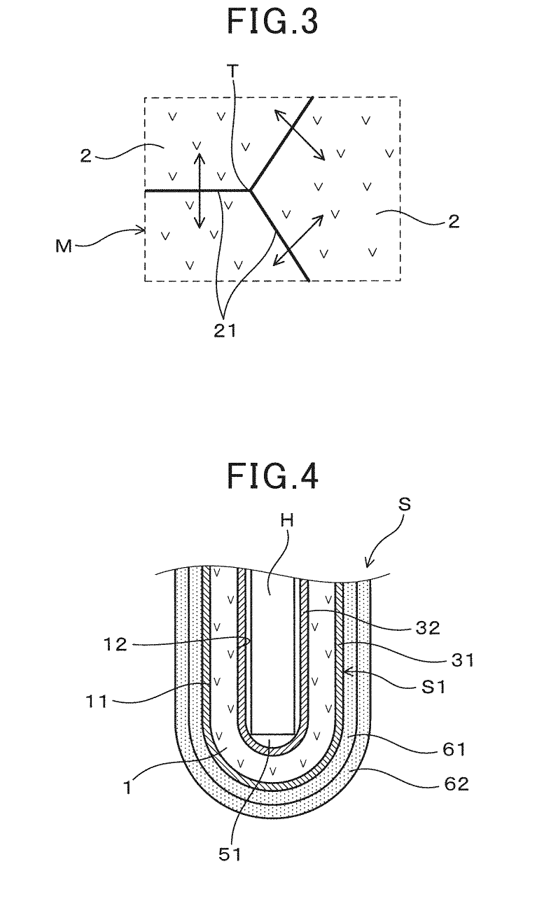

As schematically shown in FIG. 3, in the solid electrolyte phase M, pairs of solid electrolyte particles 2 adjacent to each other do not have a grain boundary impurity layer between their particle interfaces 21, and the particle interfaces are in direct contact with each other. A large number of solid electrolyte particles 2 are crystal particles of zirconia each containing a stabilizer and having ionic conductivity between adjacent crystal particles via a particle interface 21 in direct contact.

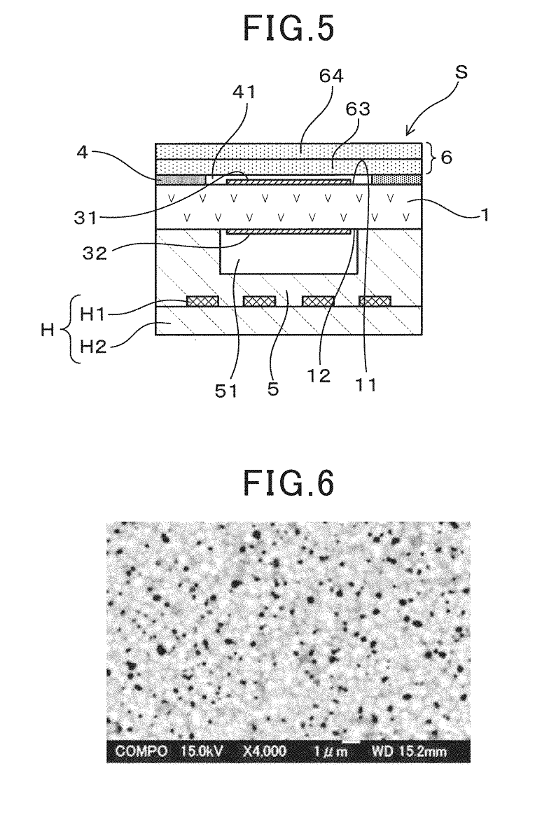

The solid electrolyte body 1 constitutes an element body portion S1 of the gas sensor element S shown in FIG. 4 and FIG. 5. The element body portion S1 has a solid electrolyte body 1, a pair of measuring electrodes 41 and a reference electrode 42. The measuring electrodes 41 are formed on a first surface 11 of the solid electrolyte body 1, and the reference electrode 42 is formed on a second surface 12 of the solid electrolyte body 1. A detailed constitution of the gas sensor element S shall be described later.

The solid electrolyte particles 2 comprises stabilized or partially stabilized zirconia containing at least one selected from, for example, yttria, calcia, magnesia and scandia as a stabilizer. The stabilizer stabilizes the crystal structure of zirconia and improves the mechanical and thermal properties. Partially stabilized zirconia containing yttria is preferably used as a stabilizer to develop excellent ionic conductivity. The content of the stabilizer is usually selected in the range of 3 mol % to 11 mol % so that desired strength and ionic conductivity can be obtained. Although the ionic conductivity improves as the content of the stabilizer increases, the bending strength tends to decrease, and therefore the content of the stabilizer is preferably in the range of 4.5 mol % to 8 mol %.

As shown in FIG. 3, the solid electrolyte phase M is constituted such that a large number of solid electrolyte particles 2 are densely compacted with each other. Two adjacent solid electrolyte particles 2 are in direct contact with each other in the particle interfaces 21, and improve the ionic conductivity between the solid electrolyte particles 2. Two particle grain boundaries where two solid electrolyte particles 2 adjoin do not substantially contain impurities derived from raw materials or others and a grain boundary layer containing impurities is not formed. The same holds true in grain boundary triple point T surrounded by three solid electrolyte particles 2, and the grain boundary impurity layer is substantially not present.

As shown in FIG. 2, the solid electrolyte body 1 is formed by dispersing a plurality of metal oxide particles 3 in the solid electrolyte phase M composed of the solid electrolyte particles 2. The metal oxide particles 3 do not substantially react with the solid electrolyte particles 2 and exist as a dispersion layer. That is, as shown in FIG. 1, direct contact between the solid electrolyte particles 2 is maintained without forming a grain boundary impurity layer between the particle interfaces 21 where the two solid electrolyte particles 2 adjoin.

Here, the structure where the particle interfaces 21 are in direct contact means a state where elements other than the constituting elements (for example, Zr, Y and O) of zirconia containing a stabilizer are not quantified when a grain boundary portion contacting the particle interface 21 is element analyzed. Specifically, it means a state where the content of the grain boundary impurities is less than the quantitation limit (for example, less than 1% by mass), preferably less than the detection limit (for example, less than 0.1% by mass), when an arbitrary point in a range, where a two-particle grain boundary or a grain boundary triple point is formed, is evaluated by TEM-EDX quantitative analysis to be described later. More preferably, for example, it is possible to say that at least 9 out of 10 arbitrary points are in direct contact when they are below the detection limit.

The metal oxide particles 3 may be any metal oxide that does not react with the solid electrolyte particles 2 and that can exist as a dispersion layer in the production process of the solid electrolyte body 1 to be described later, and, for example, oxides containing metal elements such as Al, Mg and the like can be used. Specifically, examples include alumina (that is, Al₂O₃), spinel (that is, MgAl₂O₄) and the like. By being provided in the solid electrolyte phase M in a state of particles, the metal oxide particles 3 can not only improve the strength of the solid electrolyte body 1, but also do not inhibit the direct contact between the solid electrolyte particles 2 with one another and hardly impair the ionic conductivity. As such, it is possible to strike a balance between the strength of the solid electrolyte body 1 and high ionic conductivity.

In the solid electrolyte body 1, the content of the metal oxide particles 3 is desirably 0.01% by mass to 15% by mass. By setting the content to 0.01% by mass or more, the strength of the solid electrolyte body 1 can be improved without reducing the ionic conductivity, for example, the four point bending strength according to the four point bending test similar to JIS R 1601 is 350 MPa or more, and preferably 400 MPa or more. At this time, as will be described later, it is possible to improve the bonding strength when the solid electrolyte body 1 is bonded to another member as a constituting member of the gas sensor element, and to fulfill the required properties when the solid electrolyte body 1 is crimp fixed to the housing. However, when the content exceeds 15% by mass, there is a risk that the conductive path decreases and the ionic conductivity start to drop, and therefore the content should be 15% by mass or less. Further, the phenomenon where the ionic conductivity rapidly declines when the content of the insulating metal oxide particles 3 exceeds a predetermined amount can be explained by the percolation theory.

Here, forming a grain boundary impurity layer by a reaction with the solid electrolyte particles 2 means that zirconia (that is, ZrO₂) reacts with a metal oxide. Whether or not a reaction occurs is a property peculiar to a substance, and in general, it can be understood, for example, from an alumina-zirconia state diagram that alumina and zirconia do not form a solid solution. However, under conditions where reactivity becomes high, for example, in the case of sintering a material with an extremely small particle diameter, a possibility that a very slight reaction occurs cannot be excluded. As such, it is desirable to use metal oxide particles 3 with conditioned particle diameter so that the particle diameter distribution does not contain highly reactive microparticles.

Specifically, the metal oxide particles 3 are preferably conditioned such that the particle diameter D0.1 is larger than 0.01 μm and 0.3 μm or smaller. The particle diameter D0.1 is a particle diameter where the integration ratio of the particle diameter distribution curve of the metal oxide particles 3 is 0.1%, and metal oxide particles 3 with a particle diameter equal to or less than the particle diameter are hardly included. The metal oxide particles 3 are preferably conditioned such that the particle diameter D0.1 is larger than 0.01 μm and 0.3 μm or smaller. When the particle diameter D0.1 is 0.01 μm or less, there is a possibility that a grain boundary impurity layer is formed. When the particle diameter D0.1 exceeds 0.3 μm, the metal oxide particles 3 may not disperse homogeneously throughout the entire solid electrolyte phase Mf, and effects of improving the bending strength may not be produced. Preferably, the particle diameter D0.1 is desirably in the range of 0.05 μm to 0.2 μm. In the conventional solid electrolyte body 1, grain-boundary triple-points T having a size, for example, in the order of 0.02 μm to 0.03 μm are formed, and therefore reactivity with the solid electrolyte particles 2 can be reduced by having a particle diameter D0.1 larger than 0.02 μm to 0.03 μm.

In the solid electrolyte body 1, oxygen vacancies are formed in the crystal structure of the solid electrolyte phase M by adding a stabilizer, and the solid electrolyte body 1 exhibits oxide ionic conductivity. At this time, since the particle interfaces 21 of the solid electrolyte particles 2 are in direct contact with each other without interposing the grain boundary impurity layer, as indicated by the arrows in FIG. 2, migration of the oxide ions from the particle interfaces 21 of the solid electrolyte particles 2 to the adjacent solid electrolyte particles 2 is easily achieved, and ionic conductivity is improved. The solid electrolyte body 1 preferably has an ionic conductivity at, for example, 300° C. of 6×10⁻⁶ S/cm or more. By having an ionic conductivity of 6×10⁻⁶ S/cm or more, the output sensitivity of the gas sensor element is enhanced, and a desired sensor output can be obtained at a relatively low temperature. As the ionic conductivity is more enhanced, the output sensitivity is more improved, and a stable output can be obtained. On the other hand, when the content of the stabilizer increases to enhance the ionic conductivity, the bending strength tends to degrade. To compensate for the degradation, the content of the metal oxide particles 3 can be increased, but as the content increases, the ionic conductivity rather reduces as mentioned above. Preferably, the ionic conductivity at 300° C. is in the range of 6×10⁻⁶ S/cm to 9×10⁻⁶ S/cm. The content of the stabilizer and the content of the metal oxide particles 3 can be conditioned so that the ionic conductivity falls in the range, and thus a balance between output sensitivity and bending strength can be struck.

In such solid electrolyte body 1, a pair of electrodes 41, 42 can be disposed on the first and second surfaces 11, 12 thereof, so that the element body portion S1 of the gas sensor element S can be constituted. The gas sensor element S can be disposed, for example, in an exhaust gas passage of an internal combustion engine, and be used as an exhaust gas sensor to detect a specific gas component contained in an exhaust gas to be measured. Specifically, the gas sensor element S can constitute an oxygen sensor and an air-fuel ratio sensor for detecting oxygen concentration, air-fuel ratio and the like of the exhaust gas.

As an example, as shown in FIG. 4, the gas sensor element S can be a cup-shaped gas sensor element S. The gas sensor element S has a cup-shaped solid electrolyte body 1 having a bottomed cylindrical shape, and a pair of measuring electrodes 41 and a reference electrode 42 are provided on both of the opposing inner and outer surfaces, respectively, to constitute the element body portion S1. In the solid electrolyte body 1, the outer surface is a first surface 11 on the side of the exhaust gas to be measured, and the inner surface is a second surface 12 on side of the reference gas. The internal space of the solid electrolyte body 1 is a reference gas chamber 51, and a reference electrode 42 is formed on the inner surface which is the second surface 12 facing the reference gas chamber 51. The reference gas chamber 51 communicates with the outside, and atmospheric air serving as a reference gas is introduced. Moreover, a rod-shaped heater portion H is inserted and disposed coaxially with the gas sensor element S in the reference gas chamber 51.

On the other hand, a measuring electrode 41 is formed on the outer surface which is the first surface 11 of the solid electrolyte body 1. In the outside covering the measuring electrode 41, a first protective layer 71 made of a porous ceramic layer, and a second protective layer 72 protecting the surface of the first protective layer 71 are sequentially formed. The second protective layer 72 is made of, for example, a porous ceramic layer having a larger porosity, and captures poisoning substances and the like in the exhaust gas and suppresses the poisoning substances to reach the element body portion S1.

On the first surface 11 of the solid electrolyte body 1, a lead portion and a terminal electrode (not shown in the figures) connected to the measuring electrode 41 are formed.

The gas sensor element S is usually mounted so that the element body portion S1 is positioned in the exhaust gas passage, in a state where the outer periphery is protected by a cover body (not shown in the figures). When the exhaust gas from the internal combustion engine reaches the element body portion S1, an electromotive force is generated between the pair of measuring electrodes 41 and the reference electrode 42 depending on the concentration of oxygen contained in the exhaust gas, and the electromotive force can be detected as a sensor output.

At this time, the sensor output has temperature dependency as mentioned above, but the solid electrolyte body 1 constituting the element body portion S1 has high ionic conductivity, and therefore the detection sensitivity rises. This makes it possible to detect the oxygen concentration from a state where the temperature of the element body portion S1 heated by the heater portion H is relatively low, and it is possible to feedback-control the operation of the internal combustion engine. Therefore, the controllability at the time of starting an engine improves, and it is possible to strike a balance between suppressing emissions and improving fuel efficiency.

Alternatively, as another example, as shown in FIG. 5, the gas sensor element S can be a laminated-type gas sensor element S. The gas sensor element S has a pair of measuring electrodes 41 and a reference electrode 42 on the first and second surfaces 11 and 12 facing each other with the sheet-shaped solid electrolyte body 1 interposed between the first and second surfaces. The first surface 11 is positioned on the side of the exhaust gas to be measured, and the second surface 12 on the side of the reference gas side. An insulator layer 6 forming a measured-gas chamber 61 on the side of the measuring electrodes 41, and an insulator layer 5 forming a reference gas chamber 51 on the side of the reference electrode 42 are laminated, respectively. On the surface of an insulator layer 4 on the side of the gas to be measured, a porous layer 73 and a shielding layer 74 are sequentially laminated to form a diffusion resistance layer 7. Atmosphere serving as a reference gas is introduced into the reference gas chamber 51 from the outside, and an exhaust gas is introduced into the measured-gas chamber 61 via the diffusion resistance layer 7.

The measuring electrodes 41 and the reference electrode 42 are made of precious metal electrodes such as Pt. The insulator layers 5 and 6 and the diffusion resistance layer 7 are made of ceramic sheet such as alumina. A hole portion serving as a measured-gas chamber 61 is formed in the insulator layer 6 at a position facing the measuring electrodes 41, and a groove portion serving as the reference gas chamber 51 is formed in the insulator layer 5, at a position facing the reference electrode 42. The diffusion resistance layer 7 comprises a gas permeable porous layer 73 and a gas impermeable shielding layer 74, and is constituted by covering the surface of the porous layer 73 in the laminating direction (the upper surface in the figure) with the shielding layer 74. The porous layer 73 is, for example, a porous ceramics layer conditioned to have a porosity of approximately 60 to 80%, and the shielding layer 74 is formed of a dense ceramic layer.

As such, the exhaust gas passes through the diffusion resistance layer 7 having a predetermined diffusion resistance and is introduced into the element body portion S1.

That is, the introduction of the exhaust gas from the upper surface side covered with the shielding layer 74 is blocked, and the introduction of the exhaust gas is limited only from the side surface of the porous layer 73, so that the amount of introduction of the exhaust gas can be controlled. At this time, a limiting current flows between the pair of measuring electrodes 41 and the reference electrode 42 depending on the oxygen concentration contained in the exhaust gas, and the air-fuel ratio can be detected on the basis of the limiting current.

Moreover, the gas sensor element S is integrally provided with the heater portion H laminated on the insulator layer 5 on the side of the reference gas, and heats the element body portion S1 to a desired temperature. The heater portion H comprises an insulator layer H2 made of ceramic sheet such as alumina, and a heater electrode H1 formed on the surface thereof. A heater electrode H1 is buried between the insulator layer H2 and the insulator layer 5.

In this constitution as well, the solid electrolyte body 1 constituting the element body portion S1 has high ionic conductivity, and therefore the detection sensitivity is high. This makes it possible to detect the air-fuel ratio from a state where the temperature of the element body portion S1 heated by the heater portion H is relatively low, and it is possible to feedback-control the operation of the internal combustion engine. Therefore, the controllability at the time of starting an engine improves, and it is possible to strike a balance between suppressing emissions and improving fuel efficiency.

When using the gas sensor element S, for example, as an exhaust sensor of an internal combustion engine, the gas sensor element S is generally housed and held in a cylindrical housing and is attached to the exhaust gas passage wall in a state where the surroundings are protected by the cover body. While using the exhaust sensor, regardless of whether it is the laminated-type or the cup-shaped type, the exhaust sensor is exposed to stress such as impact force from the outside, rapid heating by a built-in heater, rapid cooling by wetting and the like, and therefore strength is required. In particular, in the case of the cup-shaped type, a ceramic powder and an insulator are disposed between the outer peripheral step portion of the solid electrolyte body 1 and the upper end opening of the housing and crimp fixed, and therefore tightening force by the crimping is exerted on the solid electrolyte body 1. Even in such a case, by using the solid electrolyte body 1 having the constitution mentioned above, it is possible to have a gas sensor element S capable of fulfilling the required properties.

(Method of Producing Solid Electrolyte Body for Gas Sensor Element)

Such solid electrolyte body 1 can be produced by the following steps.

### That is:

A pulverizing step of pulverizing a raw material of the solid electrolyte particles 2, and

a slurrying step of mixing the pulverized raw material powder with a solvent to form a slurry are performed,

and more preferably, a filtering step of separating impurities together with the solvent from the raw material powder by performing centrifugal separation on the obtained slurry is performed.

Thereafter, a mixing step of adding the metal oxide particles to the separated raw material powder,

and a molding step of molding a mixed powder containing the raw material powder and the metal oxide particles into a molded body are performed.

Further, a firing step of firing the obtained molded body is performed to obtain the solid electrolyte body 1. Each of these steps is hereinafter described.

First, in the pulverizing step, solid electrolyte particles 2 as a starting material is mixed with high purity zirconia powder and high purity yttria powder and the mixture is pulverized. As for a pulverizing method, a dry or wet pulverizing method using a pulverizing apparatus using zirconia cobblestones or alumina cobblestones as media can be adopted. Preferably, zirconia cobblestones are used. In particular, in the case where a filtering step is not performed to be described later, mixing of impurities derived from the media can be suppressed by using high purity zirconia cobblestones. It is desirable that the purity of the raw material powder is, for example, 99.9% by mass or more, preferably 99.99% by mass or more. Regarding the purity of the zirconia cobblestones, it is desirable that, for example, the ratio of zirconia and a stabilizer is 99.0% by mass or more, preferably 99.5% by mass or more. In either case, the higher the purity is, the higher the effect of suppressing the formation of the grain boundary impurity layer in the solid electrolyte phase M is. When alumina cobblestones are used, although it is not necessarily limited, it is desirable that similar purities are attained.

The mixed and pulverized raw material is further mixed using a solvent to form a slurry in the slurrying step. It is desirable that the mixed powder before slurrying has, for example, an average particle size of approximately 0.2 μm to 0.8 μm, and a content of n impurities of less than 0.02% by mass, preferably 0.01% by mass or less. As for a solvent added to the mixed powder, for example, water or an aqueous solvent containing water is preferably used. The slurry is obtained by adding an appropriate amount of the aqueous solvent to the raw material powder and mixing the mixture for a sufficient time period. Alternatively, it is possible to use an organic solvent, for example, an alcohol solvent such as ethanol.

The obtained slurry is sufficiently diluted by further adding the aqueous solvent used for slurrying and is subjected to filtering using a centrifugal separator. The added solvent is preferably prepared such that the amount of the solvent in the diluted solution is, for example, twice or more larger than the amount of the solvent in the slurry, or, for example, in the order of three times larger. As a result, the raw material powder is homogeneously dispersed in the diluted solution, and trace amounts of impurities derived from the raw material powder or the zirconia cobblestones in the pulverizing apparatus contained in the slurry are easily dispersed in the solvent.

After centrifugation, it is possible to remove a trace amount of impurities together with the solvent by separating the raw material powder from the solvent. By going through the filtering step, it is possible to reduce the content of the impurities to a state where impurities are substantially not included (that is, less than the quantitation limit, preferably less than the detection limit).

Further, in the case where the raw material powder and the zirconia cobblestones have purity in the preferable range mentioned above, and the mixed powder before slurrying is in a state hardly containing impurities, even if the filtering step is omitted, it is possible to obtain effects of suppressing formation of the grain boundary impurity layer. Alternatively, in the case of using alumina cobblestones, it is possible to obtain similar effects by performing the filtering step to achieve a state where impurities are hardly contained.

After filtering, the solvent is added again to the separated raw material powder. As for the solvent, an aqueous solvent similar to the one used in the slurrying step can be used, and the same amount of the solvent as used for slurrying is added to form a slurry.

A mixing step of adding metal oxide particles 3 to this slurry is further performed. It is desirable that the purity of the metal oxide particles 3 is, for example, 99.9% by mass or more, preferably 99.99% by mass or more, and the higher the purity is, the higher the effects of suppressing the formation of the grain boundary impurity layer in the solid electrolyte phase M is. The obtained slurry is dried to a powder by spray drying, for example, in a spray drying step.

Here, the metal oxide particles 3 are high purity powder material conditioned in advance to have a predetermined particle diameter distribution, and are added and mixed so as to have a predetermined content. By adding the metal oxide particles 3 to the raw material powder after the pulverizing step, it is possible to preferably disperse the metal oxide particles 3 having a predetermined particle diameter in the solid electrolyte phase M, while microminiaturization of the metal oxide particles leading to formation of the grain boundary impurity layer can be suppressed.

The mixed powder obtained as such is molded into a predetermined shape using an ordinary press method in the molding step. The molded body obtained in the molding step is further fired at a firing temperature of, for example, 1,300° C. to 1,500° C. in the firing step to obtain the solid electrolyte body 1.

### EXAMPLES

### Example 1

A solid electrolyte body 1 was produced by performing a pulverization step, slurrying step, filtering step, mixing step, molding step, and firing step as follows. In the pulverizing step, high purity zirconia powder (purity: 99.99% by mass or more) and high purity yttria powder (purity: 99.99% by mass or more) were used as starting materials. As shown in Table 1, yttria powder was added to the zirconia powder so as to have a content of 6 mol % to prepare a raw material powder, and was mixed and pulverized by a dry process using a pulverizing apparatus using high purity zirconia cobblestones (purity: 99.95% by mass or more) as media. The average particle diameter after pulverizing the raw material powder was 0.6 μm, and the content of impurities in the raw material powder was 0.01% by mass or less.

In the subsequent slurrying step, water as a solvent was added to the mixed and pulverized raw material powder and the mixture was mixed for 6 hours to form a slurry. Thereafter, in the filtering step, the obtained slurry was diluted by adding water, and then the diluted slurry was centrifuged. The dilution conditions were as follows: The amount of water of the diluted slurry was tripled, and the vessel containing the diluted slurry was set in a centrifugal separator and centrifuged at a rotation speed of 10,000 rpm for 2 minutes. Thereafter, the separated supernatant liquid was removed, and water was added again and mixed to obtain a slurry. The amount of water added was determined to be the same as the amount added in the slurrying.

Then, in the mixing step, high purity alumina powder (purity: 99.99% by mass or more) was added and mixed as metal oxide particles 3 to the obtained slurry. As shown in Table 1, the alumina powder was added so that the particle diameter D0.1 was 0.05 μm and the content was 0.01% by mass. Thereafter, the slurry was spray-dried by spray drying to obtain a granular dry powder. Thereafter, in the molding step, the obtained granular powder was molded into a cup-shape by a rubber press method, and the mold was ground to obtain a cup-shaped molded body similar to that shown in FIG. 4. The obtained molded body was fired at 1,400° C. in the firing step to obtain the solid electrolyte body 1 containing partially stabilized zirconia as a main component (Example 1).

### Examples 2 to 8

As shown in Table 1, a solid electrolyte body 1 was produced in the same manner as that in Example 1 except that the content of the alumina powder was changed. First, high purity yttria powder was added to high purity zirconia powder so as to have a content of 6 mol % to prepare a raw material powder, and in the same manner as that in Example 1, a pulverizing step, slurrying step, and filtering step were performed. Then, in the mixing step, high purity alumina powder having a particle diameter D0.1 of 0.05 μm was added to the obtained slurry so that the content of the alumina powder was in the range of 0.05% by mass to 15% by mass. Thereafter, the spray drying step, molding step and firing step were performed to obtain the cup-shaped solid electrolyte body 1.

### Comparative Example 1

A solid electrolyte body 1 was produced in the same manner as that in Example 1 except that alumina powder as metal oxide particles 3 was not added and a mixing step was not performed. First, high purity yttria powder was added to high purity zirconia powder so as to have a content of 6 mol % to prepare a raw material powder, and a pulverizing step, slurrying step, and filtering step were performed. Then, the granular powder obtained in a spray drying step was molded into a cup-shape in a molding step, and a firing step was performed to obtain the solid electrolyte body 1.

### Examples 9 to 13

As shown in Table 1, a solid electrolyte body 1 was produced in the same manner as that in Example 1 except that the content or the particle diameter D0.1 of the alumina powder was changed. First, high purity yttria powder was added to high purity zirconia powder so as to have a content of 6 mol % to prepare a raw material powder, and in the same manner as that in Example 1, a pulverizing step, slurrying step, and filtering step were performed. In a mixing step, high purity alumina powder having a particle diameter D0.1 of 0.1 μm, 0.2 μm or 0.3 μm was added to the obtained slurry so that the content of the alumina powder was 0.01% by mass or 15% by mass, and a spray drying step, molding step, firing step were performed to obtain the cup-shaped solid electrolyte body 1.

### Comparative Examples 2 to 5

As shown in Table 1, a solid electrolyte body 1 was produced in the same manner as that in Example 1 except that the content, the particle diameter D0.1 or the timing for addition of the alumina powder was changed. First, high purity yttria powder was added to high purity zirconia powder so as to have a content of 6 mol % to prepare a raw material powder, and a pulverizing step, slurrying step, and filtering step were performed. In Comparative Examples 2 to 3, high purity alumina powder having a particle diameter D0.1 of 0.05 μm was added prior to the pulverizing step so that the content of the alumina powder was 1% by mass or 15% by mass, and following the filtering step, a spray drying step, molding step and firing step were performed. In Comparative Examples 4 to 5, high purity alumina powder having a particle diameter D0.1 of 0.01 μm was added in a mixing step of a filtering step so that the content of the alumina powder was 1% by mass or 15% by mass, and a spray drying step, molding step and firing step were performed to obtain the cup-shaped solid electrolyte body 1.

### Examples 14 to 20

High purity yttria powder was added to high purity zirconia powder so as to have a content of 4.5 mol % to prepare a raw material powder, and in the same manner as that in Example 1, a pulverizing step, slurrying step, and filtering step were performed. In Example 14, a mixing step, molding step and firing step were performed in the same manner as that in Example 1 to obtain the cup-shaped solid electrolyte body 1. In Examples 15 to 20, as shown in Table 1, high purity alumina powder having a particle diameter D0.1 of 0.05 μm to 0.2 μm was added in a mixing step so that the content of the alumina powder was 0.01% by mass or 15% by mass. Thereafter, a spray drying step, molding step and firing step were performed to obtain the cup-shaped solid electrolyte body 1.

### Examples 21 to 26

High purity yttria powder was added to high purity zirconia powder so as to have a content of 8 mol % to prepare a raw material powder, and a pulverizing step, slurrying step and filtering step were performed in the same manner as that in Example 1. In Example 21, a mixing step, molding step and firing step were performed in the same manner as that in Example 1 to obtain the cup-shaped solid electrolyte body 1. In Examples 22 to 26, as shown in Table 1, high purity alumina powder having a particle diameter D0.1 of 0.05 μm to 0.2 μm was added in a mixing step so that the content of the alumina powder was 0.01% by mass or 15% by mass. Thereafter, a spray drying step, molding step and firing step were performed to obtain the cup-shaped solid electrolyte body 1.

TABLE 1

| | | | | | | | | Four Point | | |
|---|---|---|---|---|---|---|---|---|---|---|
| Examples | | | | Al₂O₃ | Grain | Grain | Ionic | Bending | Activation | |
| Comparative | Y₂O₃ | Al₂O₃ | Al₂O₃ | Addition | Boundary | Boundary | Conductivity | Strength | Temperature | |
| Examples | (Mol %) | (Mass %) | D0.1(μm) | Time | Layer | Impurities | (S/cm) | (MPa) | (° C.) | Assessment |
| Comparative | 6 | 0 | — | — | Absent | *1) 0% | 7.3 × 10⁻⁶ | 310 | 270 | Fail |
| Examples 1 | | | | | | | | | | |
| Examples 1 | 6 | 0.01 | 0.05 | After | Absent | 0% | 7.3 × 10⁻⁶ | 420 | 270 | Good |
| | | | | Pulverization | | | | | | |
| Examples 2 | 6 | 0.05 | 0.05 | After | Absent | 0% | 7.3 × 10⁻⁶ | 440 | 270 | Good |
| | | | | Pulverization | | | | | | |
| Examples 3 | 6 | 0.1 | 0.05 | After | Absent | 0% | 7.2 × 10⁻⁶ | 450 | 270 | Good |
| | | | | Pulverization | | | | | | |
| Examples 4 | 6 | 0.5 | 0.05 | After | Absent | 0% | 7.1 × 10⁻⁶ | 470 | 280 | Good |
| | | | | Pulverization | | | | | | |
| Examples 5 | 6 | 1 | 0.05 | After | Absent | 0% | 7 × 10⁻⁶ | 500 | 280 | Good |
| | | | | Pulverization | | | | | | |
| Examples 6 | 6 | 5 | 0.05 | After | Absent | 0% | 6.8 × 10⁻⁶ | 620 | 290 | Good |
| | | | | Pulverization | | | | | | |
| Examples 7 | 6 | 10 | 0.05 | After | Absent | 0% | 6.6 × 10⁻⁶ | 770 | 300 | Good |
| | | | | Pulverization | | | | | | |
| Examples 8 | 6 | 15 | 0.05 | After | Absent | 0% | 6.4 × 10⁻⁶ | 850 | 300 | Good |
| | | | | Pulverization | | | | | | |
| Comparative | 6 | 1 | 0.05 | Before | Present | 4% | 5.4 × 10⁻⁶ | 500 | 330 | Fail |
| Examples 2 | | | | Pulverization | | | | | | |
| Comparative | 6 | 15 | 0.05 | Before | Present | 12% | 3 × 10⁻⁶ | 780 | 380 | Fail |
| Examples 3 | | | | Pulverization | | | | | | |
| Comparative | 6 | 1 | 0.01 | After | Present | 2% | 5.2 × 10⁻⁶ | 440 | 320 | Fail |
| Examples 4 | | | | Pulverization | | | | | | |
| Comparative | 6 | 15 | 0.01 | After | Present | 10% | 2.4 × 10⁻⁶ | 670 | 390 | Fail |
| Examples 5 | | | | Pulverization | | | | | | |
| Examples 9 | 6 | 0.01 | 0.1 | After | Absent | 0% | 7.3 × 10⁻⁶ | 410 | 270 | Good |
| | | | | Pulverization | | | | | | |
| Examples 10 | 6 | 15 | 0.1 | After | Absent | 0% | 6.4 × 10⁻⁶ | 670 | 290 | Good |
| | | | | Pulverization | | | | | | |
| Examples 11 | 6 | 0.01 | 0.2 | After | Absent | 0% | 7.3 × 10⁻⁶ | 400 | 270 | Good |
| | | | | Pulverization | | | | | | |
| Examples 12 | 6 | 15 | 0.2 | After | Absent | 0% | 6.5 × 10⁻⁶ | 490 | 290 | Good |
| | | | | Pulverization | | | | | | |
| Examples 13 | 6 | 0.01 | 0.3 | After | Absent | 0% | 7.3 × 10⁻⁶ | 350 | 270 | Good |
| | | | | Pulverization | | | | | | |
| Examples 14 | 4.5 | 0.01 | 0.05 | After | Absent | 0% | 6.5 × 10⁻⁶ | 430 | 290 | Good |
| | | | | Pulverization | | | | | | |
| Examples 15 | 4.5 | 0.01 | 0.1 | After | Absent | 0% | 6.5 × 10⁻⁶ | 420 | 290 | Good |
| | | | | Pulverization | | | | | | |
| Examples 16 | 4.5 | 0.01 | 0.2 | After | Absent | 0% | 6.5 × 10⁻⁶ | 410 | 290 | Good |
| | | | | Pulverization | | | | | | |
| Examples 17 | 4.5 | 0.01 | 0.3 | After | Absent | 0% | 6.5 × 10⁻⁶ | 370 | 290 | Good |
| | | | | Pulverization | | | | | | |
| Examples 18 | 4.5 | 15 | 0.05 | After | Absent | 0% | 6 × 10⁻⁶ | 860 | 300 | Good |
| | | | | Pulverization | | | | | | |
| Examples 19 | 4.5 | 15 | 0.1 | After | Absent | 0% | 6 × 10⁻⁶ | 700 | 300 | Good |
| | | | | Pulverization | | | | | | |
| Examples 20 | 4.5 | 15 | 0.2 | After | Absent | 0% | 6.1 × 10⁻⁶ | 580 | 300 | Good |
| | | | | Pulverization | | | | | | |
| Examples 21 | 8 | 0.01 | 0.05 | After | Absent | 0% | 8.9 × 10⁻⁶ | 420 | 230 | Good |
| | | | | Pulverization | | | | | | |
| Examples 22 | 8 | 0.01 | 0.1 | After | Absent | 0% | 8.8 × 10⁻⁶ | 410 | 230 | Good |
| | | | | Pulverization | | | | | | |
| Examples 23 | 8 | 0.01 | 0.2 | After | Absent | 0% | 8.8 × 10⁻⁶ | 400 | 230 | Good |
| | | | | Pulverization | | | | | | |
| Examples 24 | 8 | 15 | 0.05 | After | Absent | 0% | 7.8 × 10⁻⁶ | 620 | 260 | Good |
| | | | | Pulverization | | | | | | |
| Examples 25 | 8 | 15 | 0.1 | After | Absent | 0% | 7.9 × 10⁻⁶ | 540 | 260 | Good |
| | | | | Pulverization | | | | | | |
| Examples 26 | 8 | 15 | 0.2 | After | Absent | 0% | 7.9 × 10⁻⁶ | 420 | 250 | Good |
| | | | | Pulverization | | | | | | |

*1): 0% shows being less than detection limit (9 points out of 10 points)

(Assessment by STEM-EDX Quantitative Analysis)

Regarding each of the solid electrolyte bodies 1 of Examples 1 to 26 and Comparative Examples 1 to 5 obtained in a manner described above, composition of a grain boundary impurity layer was examined with an energy dispersive X-ray analyzer (hereinafter referred to as EDS) using a scanning transmission electron microscope (hereinafter referred to as STEM). An observation part of a test piece was processed with a focusing ion beam (hereinafter referred to as FIB) apparatus (that is, “VIOLA” manufactured by FEI Company Japan Ltd.), and a thin film sample having a thickness of 0.1 μm was obtained. Next, the thin film sample was observed using STEM (that is, “JEM-2800” manufactured by JEOL Ltd.), and a STEM photograph was obtained.

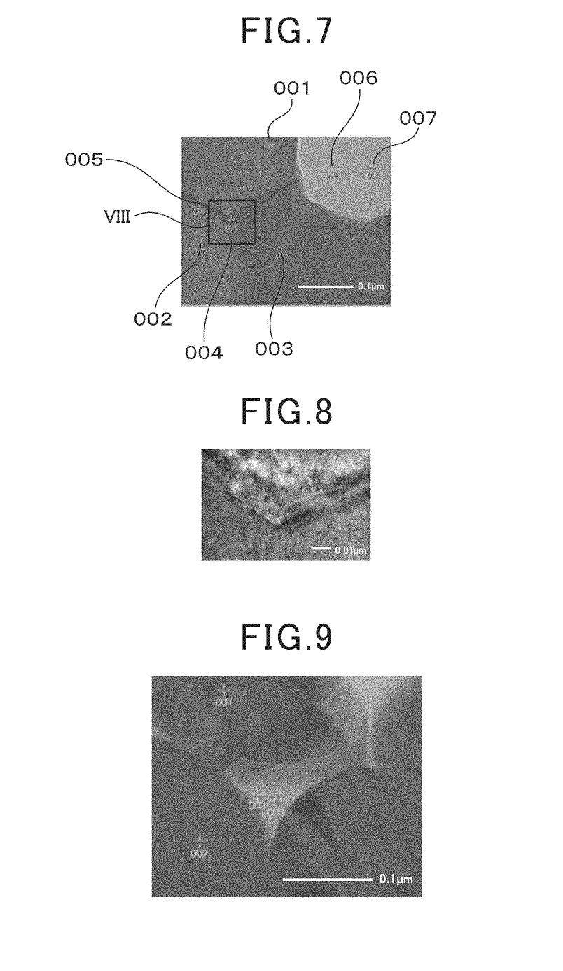

As shown in a representative example of a STEM photograph of Example 6 (with magnification of 4,000) in FIG. 6, a phase where the metal oxide particles 3 (that is, alumina particles) are dispersed in the entire solid electrolyte phase M comprising solid electrolyte particles 2 (that is, partially stabilized zirconia) was confirmed. Moreover, in the enlarged photographs shown in FIG. 7 and FIG. 8, the particle interfaces 21 of the solid electrolyte particles 2 are in close contact with each other, and corner portions serving as boundaries of the three solid electrolyte particles 2 are further formed at the grain-boundary triple-points, and grain boundary impurity layer was not confirmed.

As shown in FIG. 7, STEM-EDX quantitative analysis was performed on arbitrary plural points (that is, analysis points 001 to 007) including two particle grain boundary where two solid electrolyte particles 2 are in contact. Table 2 shows the results of quantitative determination of compositions of Al component, Si component, Y component, and Zr component in terms of oxides. As is clear from Table 2, Al component and Si component were not detected for the solid electrolyte phase M containing two particle grain boundary (that is, analysis points 001 to 005).

TABLE 2

Component Composition (Mass %)

| Analysis Point | Al₂O₃ | SiO₂ | Y₂O₃ | ZrO₂ |
|---|---|---|---|---|
| 001 | — | — | 14.9 | 85.1 |
| 002 | — | — | 15.1 | 84.9 |
| 003 | — | — | 14.8 | 85.2 |
| 004 | — | — | 15.9 | 84.1 |
| 005 | — | — | 15.8 | 84.2 |
| 006 | 100.0 | — | — | — |
| 007 | 95.8 | — | — | 4.2 |

On the other hand, as shown in the STEM photograph of Comparative Example 4 in FIG. 9, a white streaky grain boundary impurity layer was observed in the particle interfaces 21 of the solid electrolyte particles 2, and a grain boundary impurity layer surrounded by three solid electrolyte particles 2 in the grain-boundary triple-points T was confirmed. Moreover, Table 3 shows the results of STEM-EDX quantitative analysis performed on arbitrary plural points (that is, analysis points 001 to 004) including the grain-boundary triple-points T. As is clear from Table 3, Al component, Si component, and P component were detected for the grain-boundary triple-points T (that is, analysis points 003 to 004).

TABLE 3

| | Component Composition (Mass %) | | | | |
|---|---|---|---|---|---|
| Analysis Point | Al₂O₃ | SiO₂ | P₂O₅ | Y₂O₃ | ZrO₂ |
| 001 | — | — | — | 6.9 | 93.1 |
| 002 | — | — | — | 12.1 | 87.9 |
| 003 | 11.5 | 54.8 | — | — | 33.6 |
| 004 | 8.6 | 61.4 | 9.4 | — | 20.6 |

For each of the obtained solid electrolyte body 1 of each Example and Comparative Example, 10 arbitrary points in the two particle grain boundary where two solid electrolyte particles 2 were in contact were selected, and the presence or absence of the grain boundary impurity layer was determined. Specifically, STEM-EDX quantitative analysis was performed on the selected 10 points, and compositions of Al component, Si component, Y component, and Zr component were quantitatively determined in terms of oxides. For example, as shown in Table 2, when the content of an atom other than Zr, Y, and O was less than the detection limit (that is, less than 0.1% by mass), it can be considered that impurities do not exist in the grain boundary. Further, in the case where quantitative analysis was performed at 10 arbitrary points, and when a determined quantity of an atom other than Zr, Y and O was less than the detection limit at 9 points or more in the 10 points, the content of grain boundary impurities was determined to be 0%. At this time, the solid electrolyte phase M was determined to have no grain boundary impurity layer (that is, there was direct contact), and in other cases it was determined to have a grain boundary impurity layer. The results are shown together in Table 1. Further, in Table 1, the grain boundary impurity layer is abbreviated as a grain boundary layer.

As is evident from Table 1, in each of Examples 1 to 26, the content of the grain boundary impurities was 0%, and it was determined that there was no grain boundary impurity layer. At this time, in Examples 1 to 26, it was confirmed that the determined quantity at 10 points out of the 10 points analyzed were less than the detection limit, and did not have grain boundary impurities in the two particle grain boundary and were in direct contact. On the other hand, in Comparative Examples 2 to 5 where alumina particle diameter was small or alumina was added before a pulverizing step, it was determined that there was a grain boundary impurity layer. That is, it was confirmed that the content of the impurities in the grain boundary was 2% by mass to 12% by mass, and it was a contact via the grain boundary impurity layer.

(Assessment of Ionic Conductivity)

Regarding the solid electrolyte body 1 of each of Examples 1 to 26 and Comparative Examples 1 to 5, the ionic conductivity was measured as follows. Each solid electrolyte body 1 was cut to an appropriate size and a pair of electrodes made of Pt were formed on both sides of the solid electrolyte body 1 by screen printing. The ionic conductivity of the obtained test piece was measured at 300° C. The results are shown together in Table 1.

(Assessment by Four Point Bending Tests)

Moreover, regarding the solid electrolyte body 1 of each of Examples 1 to 26 and Comparative Examples 1 to 5, a four point bending test similar to JIS R 1601 was conducted. First, assessment samples were prepared by cutting each solid electrolyte body 1 to a width of approximately 5 mm and a length of approximately 45 mm. Four point bending tests were performed for 10 times on these assessment samples for each solid electrolyte body 1, and an average value was calculated. The results are shown together in Table 1.

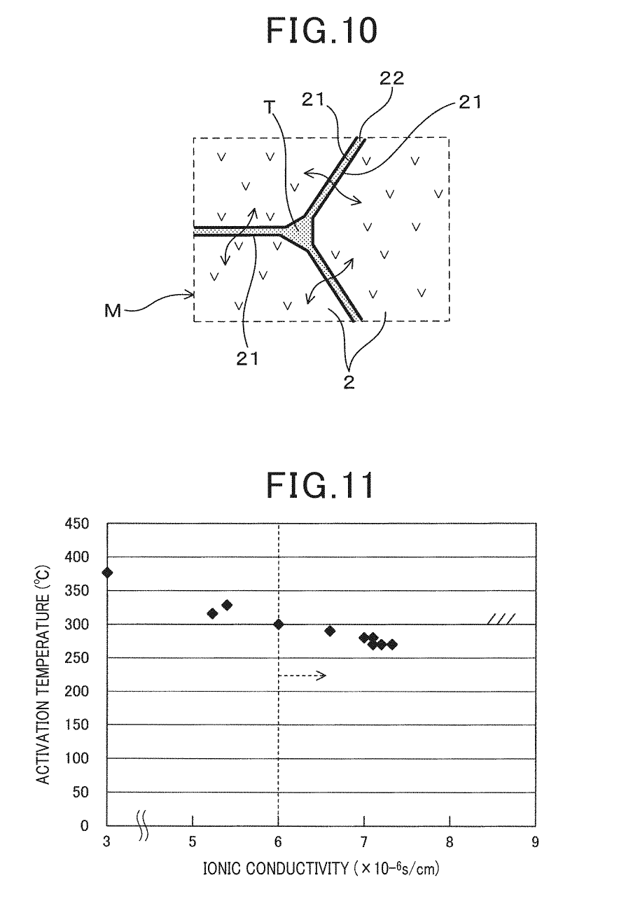

As is clear from Table 1, the ionic conductivity at 300° C. in each of Examples 1 to 26 was 6×10⁻⁶ S/cm to 8.9×10⁻⁶ S/cm, which is a good result. Moreover, the four point bending strength was 350 MPa to 860 MPa, which exhibited improvements compared to 310 MPa of Comparative Example 1 where alumina is not contained. On the other hand, in Comparative Examples 2 and 3 where alumina was added before the pulverizing step and Comparative Examples 4 and 5 where particle diameter D0.1 of alumina was smaller than 0.01 μm, a grain boundary impurity layer was formed, and although the four point bending strength improved, the ionic conductivity was lower than 6×10⁻⁶ S/cm. As schematically shown in FIG. 10, it is considered that the ionic conduction is inhibited by the formation of a grain boundary impurity layer.

(Assessment of Sensor Properties)

Furthermore, a reference electrode 42 made of Pt was formed in the inner surface to be the second surface 12 of each cup-shaped solid electrolyte body 1. Moreover, the measuring electrodes 41, the lead portion, and the terminal electrode were formed in the outer surface to be first surface 11 of the solid electrolyte body 1, and the first and second protective layers 71 and 72 were further formed. These electrodes, lead portions, and protective layers can be formed by a well-known method. In this manner, the gas sensor element S shown in FIG. 4 was produced, and assessment of sensor reactivity of a gas sensor using the gas sensor element S was performed. Assessment tests were performed by installing a gas sensor in the exhaust flow passage of a model gas apparatus, and a model gas having an air-fuel ratio conditioned to λ, =0.90 (that is, on the rich side) by mixing carbon monoxide, methane, propane and nitrogen was circulated. Each temperature (that is, an activation temperature) at which the rich output VR became 0.6 V, which is the minimum output that can be determined in the control circuit, was measured by conditioning the element temperature according to the temperature of the circulating gas. The temperatures are shown together in Table 1.

A case where the rich output VR became 0.6 V at a temperature of 300° C. or less was assessed as “pass” from the perspective of low temperature activation, and a case where the rich output VR became 0.6 V at a temperature above 300° C. was assessed as “fail”. As is clear from Table 1, in each of Examples 1 to 26, the rich output was 0.6 V at a temperature of 300° C. or less, and a good result was obtained. On the other hand, in Comparative Examples 2 and 3 where alumina was added before the pulverizing step and Comparative Examples 4 and 5 where particle diameter D0.1 of alumina was smaller than 0.1 the temperature at which the rich output became 0.6 V was between 320° C. and 390° C., which is higher than 300° C.

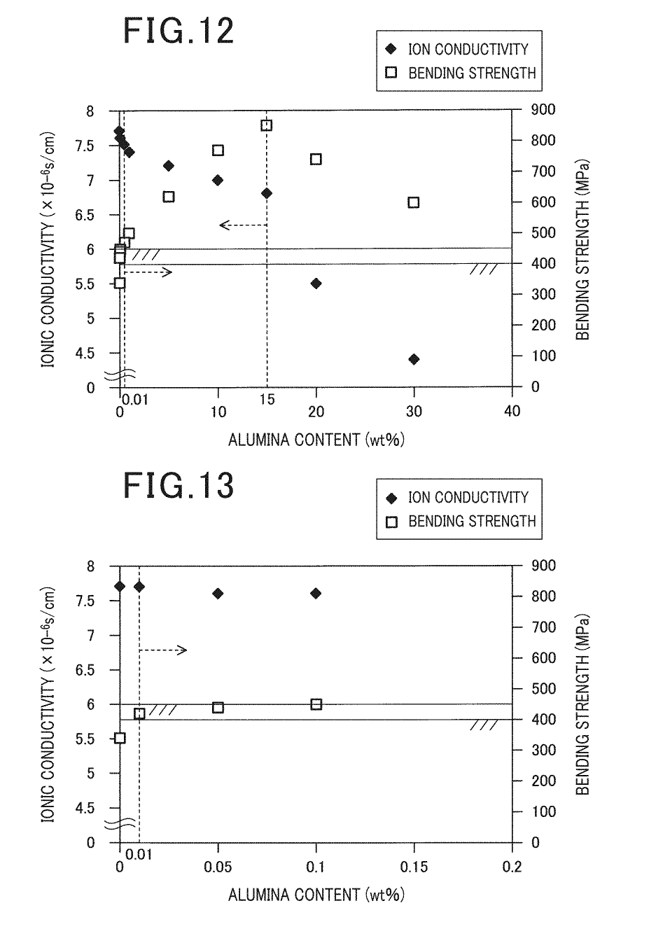

From the results obtained in these Examples and Comparative Examples, as shown in FIG. 11, it can be said that there is a correlation between the ionic conductivity and the activation temperature, and that, when the ionic conductivity is 6×10⁻⁶ S/cm or more, the rich output becomes 0.6 V at a relatively low temperature at 300° C. or lower. Moreover, as shown in FIG. 12 and FIG. 13, there is a negative correlation between the alumina content and the ionic conductivity, but there is a positive correlation between the alumina content and the four point bending strength. In order to have an ionic conductivity of 6×10⁻⁶ S/cm or more, it is desirable that the alumina content is preferably 15% by mass or less, and when the alumina content is 0.01% by mass or more, It is possible that the four point bending strength be 400 MPa or more. In the assessments shown in Table 1, a case where there is no grain boundary impurity layer, the ionic conductivity is 6×10⁻⁶ S/cm or more, the four point bending strength is 400 MPa or more, and the activation temperature is 300° C. or less was assessed as “good”, and all others were assessed as “fail”s.

### Comparative Example 6

When the content of the yttria powder in the raw material powder was 6% by mass, the media of the pulverizing apparatus were changed to alumina cobblestones, and after performing a pulverizing step and slurrying step in the same manner as in that of Comparative Example 1, a mixing step was performed without performing a filtering step to obtain a granular powder. Thereafter, a molding step was performed, and the obtained molded body was fired to obtain a cup-shaped solid electrolyte body 1.

In the same manner, a grain boundary impurity layer was formed by performing STEM-EDX quantitative analysis, and the content of impurities in the grain boundary was 12% by mass. Moreover, although the four point bending strength was 400 MPa, the ionic conductivity was 2.6×10⁻⁶ S/cm, which was much lower than 6×10⁻⁶ S/cm.

### Comparative Example 7

When the content of the yttria powder in the raw material powder was 6% by mass, and the media of the pulverizing apparatus were changed to zirconia cobblestones, a mixing step was performed in the same manner as that of Comparative Example 1 without performing a filtering step to obtain a granular powder. Thereafter, a molding step was performed, and the obtained molded body was fired to obtain a cup-shaped solid electrolyte body 1.

Similarly, when STEM-EDX quantitative analysis was performed, the content of grain boundary impurities was 0% (that is, 9 points out of 10 points quantitatively analyzed were below the detection limit), and it was determined that there was no grain boundary impurities. Moreover, the ionic conductivity at 300° C. was 6.8×10⁻⁶ S/cm, which was lower than that of the solid electrolyte body 1 of Comparative Example 1. The four point bending strength was 330 MPa, which was much lower than 400 MPa.

The present disclosure is not limited to each of the embodiments mentioned above, and can be applied to various embodiments in the range not departing from the substance thereof.

For example, in the embodiments mentioned above, the solid electrolyte body 1 has a constitution where the solid electrolyte body 1 only has the solid electrolyte phase M and does not contain particles other than the solid electrolyte particles 2. However, the present disclosure is not limited thereto. Specifically, it is possible to adopt a constitution including particles other than the solid electrolyte as a dispersed phase within a range not impeding the ionic conductivity of the solid electrolyte phase M. Even in such a case, it is a constitution where a grain boundary impurity layer is not formed in the particle interfaces 21 between the solid electrolyte particles 2 resulting from particles to be dispersed phase, and the solid electrolyte particles 2 are in direct contact with each other, which is the same as the embodiment mentioned above, and similar effects can be obtained. Moreover, although a case of using a gas sensor element as an exhaust sensor of an internal combustion engine was described, it is possible to apply the gas sensor element to an arbitrary sensor other than an internal combustion engine or an exhaust sensor. Moreover, the constitution of the gas sensor element is not limited to those shown in FIG. 4 and FIG. 5, and can be changed as appropriate.

1. A solid electrolyte body for a gas sensor element containing solid electrolyte particles made of zirconia containing a stabilizer, and metal oxide particles, the solid electrolyte body having a structure in which the metal oxide particles are dispersed in a solid electrolyte phase in which a large number of the solid electrolyte particles are aggregated,
wherein, in the solid electrolyte phase, pairs of the solid electrolyte particles adjoining each other do not have a grain boundary impurity layer between their particle interfaces, and the particle interfaces directly contact with each other.

2. The solid electrolyte body for a gas sensor element according to claim 1, wherein, in the solid electrolyte phase, the content of impurities between the particle interfaces is less than the detection limit.

3. The solid electrolyte body for a gas sensor element according to claim 1, wherein the content of the metal oxide particles is 0.01% by mass to 15% by mass

4. The solid electrolyte body for a gas sensor element according to claim 1, wherein the metal oxide particles comprise Al₂O₃ having a particle diameter D0.1 larger than 0.01 μm and 0.3 μm or less.

5. The solid electrolyte body for a gas sensor element according to claim 1, wherein the metal oxide particles comprise Al₂O₃ having a particle diameter D0.1 of 0.05 μm to 0.2 μm.

6. The solid electrolyte body for a gas sensor element according to claim 1, wherein the solid electrolyte particles comprise partially stabilized zirconia comprising 4.5 to 8 mol % of yttria as the stabilizer.

7. The solid electrolyte body for a gas sensor element according to claim 1, wherein the solid electrolyte body has an ionic conductivity at 300° C. of 6×10⁻⁶ S/cm or more.

8. A method of producing the solid electrolyte body for a gas sensor element according to claim 1, comprising the steps of:
a pulverizing step of pulverizing a raw material of the solid electrolyte particles;
a slurrying step of mixing a pulverized raw material powder with a solvent to form a slurry;
a filtering step of separating impurities together with the solvent from the raw material powder by performing centrifugal separation treatment on the obtained slurry;
an adding step of adding the metal oxide particles to the separated raw material powder; and
a molding step of molding a mixed powder containing the raw material powder and the metal oxide particles into a molded body.

9. A gas sensor element using the solid electrolyte body for a gas sensor element according to claim 1, wherein the gas sensor element comprises the solid electrolyte body for a gas sensor element and a pair of electrodes, and
a first electrode of the pair of electrodes is provided on a first surface of the solid electrolyte body for a gas sensor element contacting a gas containing a specific gas component, and a second electrode of the pair of electrodes is provided on a second surface of the solid electrolyte body for a gas sensor element contacting a reference gas.
